(19) United States
(12) Patent Application Publication
(10) Pub. No.: US 2003/0085230 A1
(43) Pub. Date: May 8, 2003

(54) Housing for an incubator with lockable inner receptacle

(76) Inventor: Egon Hessler, Hasselroth (DE)

Correspondence Address: BAKER + HOSTETLER LLP, WASHINGTON SQUARE, SUITE 1100, 1050 CONNECTICUT AVE. N.W., WASHINGTON, DC, 20036-5304, US

(21) Appl. No.: 10/222,873

(22) Filed: Aug. 19, 2002

(30) Foreign Application Priority Data
Sep. 14, 2001 (DE) DE 10145459.7

(51) Int. Cl. A47J 39/00; A47J 41/00; B65D 81/38; B65D 83/72

(52) U.S. Cl. 220/592.2

(57) ABSTRACT

A housing for a gassing incubator has an interior container, which can be sealed off thermally with respect to the outer atmosphere, whose interior space is accessible via a front door of the housing; the interior container is at least partially surrounded by a thermally insulating sheath, consisting of at least four plate-shaped, heat-insulating elements, which are connected with one another in the area of their edges and surround the interior container in the form of a jacket; advantageously, the back side of the sheath is also closed with a plate-shaped, heat-insulating element in the area of the back wall of the incubator. The plate-shaped elements are made of material with a low heat conductivity and are placed at a distance to the inside of the outer housing. Thus, an interior space filled with air is formed between the interior container and the outer housing, which is subdivided by the sheath into two spaces, which are sealed off thermally with respect to one another, with their own convection. The plate-shaped elements are made of a foam-shaped thermoplastic, which has polystyrene and polyphenylene ether.

The invention refers to a housing for an incubator, in particular, a gassing incubator with an interior container that can be sealed off thermally, with respect to the outside atmosphere, whose interior space is accessible via a front door of the housing, wherein the interior container is at least partially surrounded, at a distance, by a sheath made of at least one material with a low heat conductivity, and a method for the formation of a thermally insulating sheathing of the interior container.

From DE 38 15 528, a gassing incubator for the cultivation of human or animal cells or tissues is known, with an interior housing that can be closed by a door, which interior housing is surrounded by a heat-insulating, outer housing. The outer housing has side walls, a back wall, and a cover and bottom and is lined with a suspended heat insulation body on its inside, wherein a gap is formed between the interior housing and the heat insulation body, at least in the area of the side walls and the upper side.

A relatively expensive lining of the outer housing with the heat insulation body on the inside proves to be problematic, wherein previously suitably cut individual parts are provided for the lining.

The goal of the invention is to develop a low-price heat insulation for an interior container which can be sealed off thermally, which insulation retains its dimensional stability even at temperatures in the range of 90-100° C.—as they appear during sterilization.

The goal is attained in that the sheath has at least four plate-shaped, heat-insulating elements, which are connected with one another and surround the interior container in the form of a jacket, wherein the plate-shaped elements are placed at a distance to the interior of the outer housing.

It has proved particularly advantageous to construct the thermally insulating sheath from plate-shaped, heat-insulating elements so that even with increased temperatures—for example, during sterilization processes in the temperature range of 100° C.—it remains dimensionally stable.

Advantageous developments of the invention are given in claims 2 to 6.

In one advantageous development according to claim 1, the sheath is open on its side, provided to the front side, or to the side provided for the front door, whereas it has an additional plate-shaped element on its back side, opposite the front door.

The plate-shaped elements are connected with one another in the area of the edges.

In another advantageous development of the invention, the plate-shaped elements are to be connected with one another, in a form-locking manner, by grooves or indentations and cam-like elevations in the area of the edges, which mesh into indentations of an adjacent plate-like element.

The plate-shaped elements are preferably made of a foam-like thermoplastic, which has polystyrene and polyphenylene ether. Between the thermally insulated interior container and the outer housing, an interior space filled with air is present, which—with the exception of the front side—is subdivided, by the thermally insulating sheath, at least in part, into two spaces which are sealed off thermally with respect to one another, with their own convection flow.

In an advantageous development, the support of the interior container is carried out in the front area of the housing, wherein for the purpose of thermal decoupling, between the interior container and the outer housing, affixing means—for example, screws—made of plastic, or affixing means with a thermally insulating surface are used. On its coldest side in the bottom area, the interior container is also connected with the outer housing by thermally conducting affixing means,—such as screws.

The invention is attained for a method for the formation of a thermal insulation of an interior container for an incubator, in which the interior container is accessible via a front door of the housing, and at least partially, is surrounded by a thermally insulating sheath made of at least four plate-like, heat-insulating elements, in that a material in the form of granules, which has expanding polystyrene and polyethylene, is introduced into a mold corresponding to the plate-shaped elements of the sheath and is pressed to a thermally insulating, plate-shaped molding by supplying steam. In addition to the steam, a gas such as pentane is also needed, which is added to the granules by the producer of the material.

Preferably, for the formation of the plate-shaped elements for the sheath, a compound consisting of a mixture of EPS (expandable polystyrene) and PPE is used in the form of granules, which can be purchased from Deutsche Shell Chemie GmbH, 65727, Eschborn, under the name Caril. The plate-shaped elements are produced by relatively simple, low-priced molds, in which moldings for two side walls, cover, bottom, and back wall of the outer housing can be especially adapted to the geometry of the individual application.

The plates can be transported and handled advantageously and very simply until the assembling of the housing, since a space-intensive cavity formation occurs only when the housing is set up.

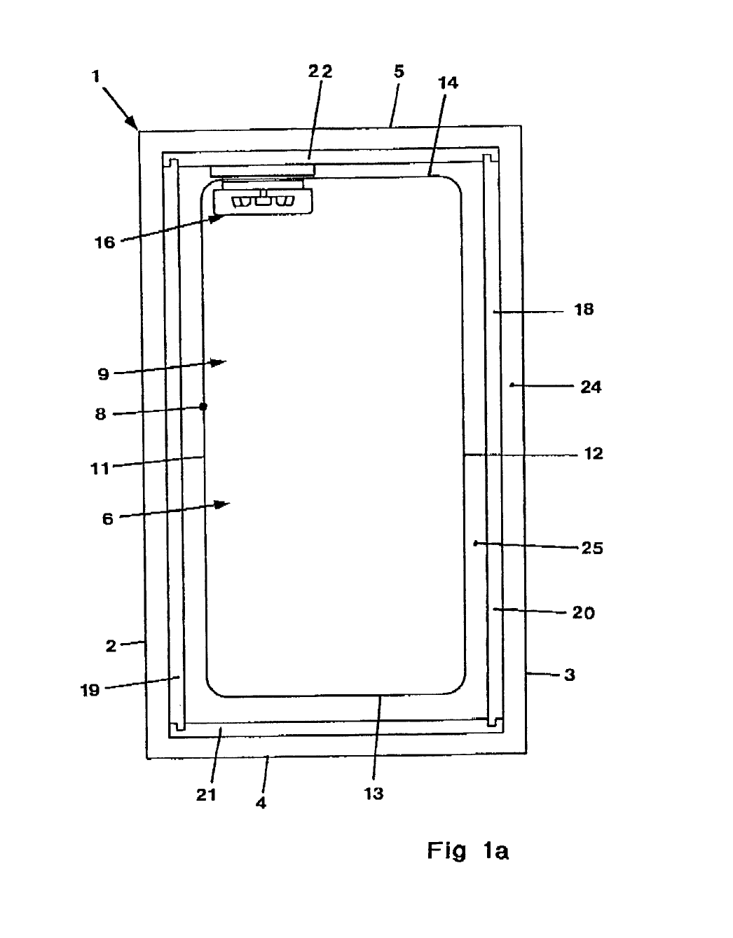

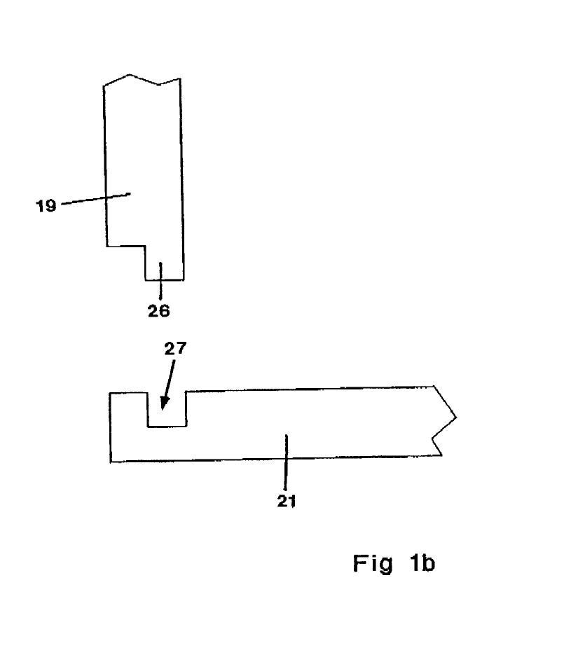

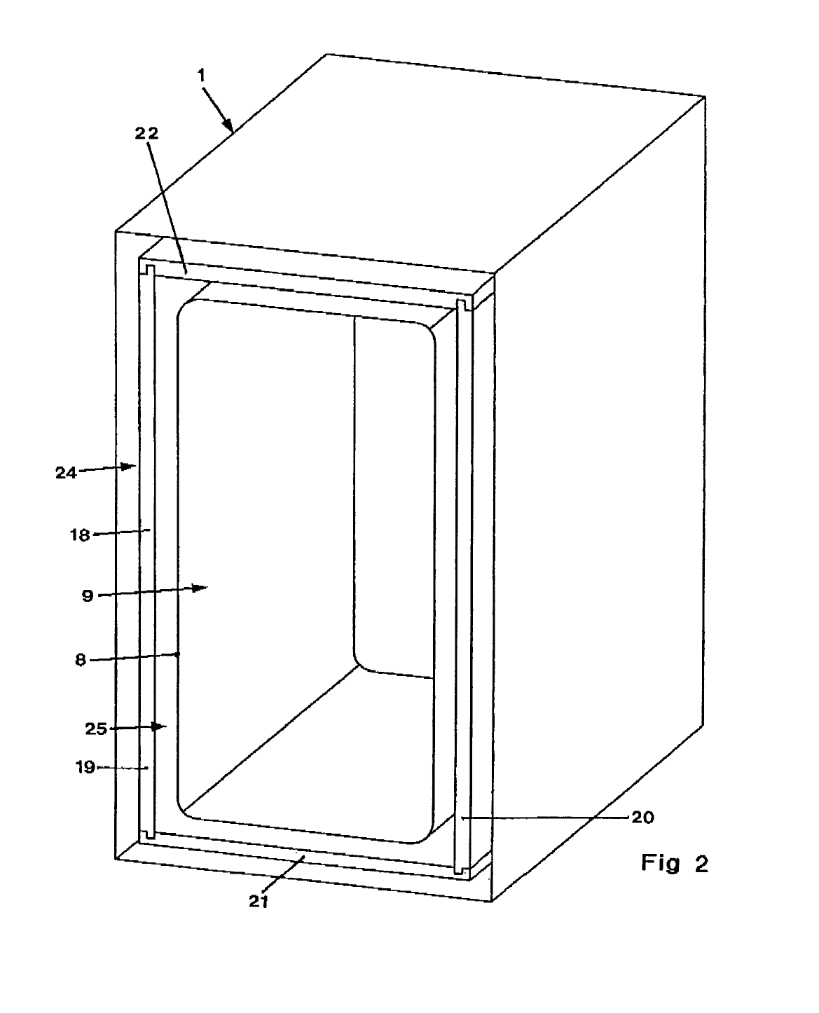

The object of the invention is explained in more detail with the aid of FIGS. 1a, 1b, and 2*. *[Figures were not supplied to translator.]

FIG. 1a shows a longitudinal section through a housing, which is being set up for a gassing incubator with the thermally insulating sheath (seen from the back side).

FIG. 1b shows a form-locking connection in the area of the edges between two heat-insulating, plate-shaped elements as a part of the sheath.

FIG. 2 shows, in a perspective representation, the setting up of the thermally insulating elements.

In accordance with FIG. 1a, the housing 1 has two side walls 2, 3, a housing bottom 4, and a cover 5 of the upper housing part. The back wall is symbolically hinted at with reference number 6.

In the interior of the housing 1, there is an interior container 8 with an interior space 9 as the actual treatment space of the incubator, wherein the interior container 8 has side walls 11, 12, a bottom area 13, and an upper cover area 14. There is a gas supply for the interior space 9, indicated here schematically, in the cover area 14, together with a ventilator and a sensor unit, which are shown symbolically and are provided with the reference number 16, as a complex which belongs together.

A thermally insulating sheath 18 with the two lateral, plate-shaped elements 19, 20, the plate-shaped element 21 in the bottom area 21, and the upper element 22 in the cover area, is placed between the interior container 8 and the outer housing 1, wherein, there is a distance between the sheath 18 and the interior container 8 and between the sheath 18 and the outer housing 1, so that seen in the longitudinal section, two separate gaps 24 (outside) and 25 (inside) are formed. The gaps 24, 25 are insulated thermally with respect to one another because of the sheath 18, so that each of the two gaps has its own convection flow; preferably, air is found in the two gaps 24, 25. Since the interior container is also surrounded by a plate-shaped, heat-insulating element on its back side, the two gaps are also present in the area of the back side of the incubator, which is not depicted here, whereas the opening of the interior container which is directed to the front side is not surrounded by the sheath, consisting of plate-shaped, heat-insulating elements.

With the aid of FIG. 1b, the connection of a lateral element 19 of the sheath 18, which is represented broken, with an element 21 in the bottom area, which is also represented broken, can be recognized schematically, wherein the interplay of a nose-like projection 26 of the plate-shaped element 19 and the recess or groove 27 of the plate-shaped element 21 in the bottom area, which is suitable for this, can be recognized. Thus, the groove 27, seen in the profile, has a recess, into which the nose-shaped elevation or projection 26 can be inserted; in addition, it is possible to provide for measures against a shifting along the longitudinal axis of the groove 27,—for example, by closing off the groves in the pertinent area of the edges. In this way, trough-like grooves are formed, which no longer permit a shifting of the nose-like projection 26 of the adjacent element 19, provided for the connection, along the groove 27. Furthermore, the opening of the sheath (not depicted here), directed to the back wall 6 of the housing, is closed by an additional plate-shaped, heat-insulating element.

Moreover, it is also possible to provide a form-locking connection between two adjacent, plate-shaped elements of the thermally insulating sheath, wherein swallow tail-like prongs mesh into correspondingly shaped grooves.

When using plate-shaped, thermally insulating elements 19, 20, 21, 22 made of a plastic based on polymer, a sufficient stability for the preliminary assembling of the sheath 18 exists, so that it can be introduced into the housing 1 as a compact component.

FIG. 2 shows, in a perspective view, a housing 1 in the process of being set up, whose back side is still open, so that both the interior space 9 of the interior container 8, as well as the sheath 18, can be at least partially recognized.

Thus, between the thermally insulating sheath 18, with its side walls 19, 20, and the elements 21 in the bottom area and the cover 22 in the upper area, one can see that a gap 24 and 25, which is thermally insulating with respect to the interior container or with respect to the outer housing, is provided, which provides an intensive thermal insulation, wherein the two gaps 24, 25 are closed off, with respect to one another, and have their own thermal convection.

In the course of the complete assembly, it is possible to seal off the interior container 8 by a back wall, for example, made of metal, which can be provided optionally with heat exchanger elements (heating; cooling). Furthermore, the thermally insulating sheath 18 on the back side of the housing 1 (directed to the back wall 6) can subsequently also be closed with the aid of an additional plate-like, thermally insulating element, which is not depicted here for the purpose of a better overview.

The interior container 8 and the outer housing 1 are preferably made of sheet metal, wherein the interior container 8 is preferably made of stainless steel for the purpose of improved maintenance and for other possibilities. The thermally insulating sheath 18 preferably consists of plate-shaped elements, which are produced from an interpolymer consisting of expandable polystyrene (EPS) and modified polyphenyl [sic; polyophenylene] ether (PPE) in the form of granules. Such granules of expandable particles can be obtained from Shell Chemicals Europe under the name “Caril.”

The production of the plate-shaped, thermally insulating elements 19, 20, 21, 22 and the other plate-shaped, thermally insulating element for the back wall is, as a rule, carried out in a Styropor-processing plant, where a material, in the form of granules, is pressed into a mold and is expanded by the addition of hot water vapor, wherein the material can be pressed into cohesive, plate-shaped particles as a result of the expansion effect. As a result of the grooves or indentations and nose-like projections or elevations which fit with one another, the parts can simply be stuck together in the final assembly; it is also possible, however, to join the parts with one another by means of prongs or swallow tail-like, form-locking connections.

The low-cost production process, the space-saving transport, the simple preliminary assembly, and the relatively simple disposal in the case of housings—especially housings for incubators—which are intended for scrap, have proved to be particularly advantageous.

1. Housing for an incubator, especially a gassing incubator, with an interior container, which can be sealed off thermally with respect to the outside atmosphere, whose interior space is accessible via a front door of the housing, wherein the interior container is at least partially surrounded, at a distance, by a thermally insulating sheath made of at least one material with a low heat conductivity, characterized in that the sheath (18) has at least four plate-shaped, heat-insulating elements (19, 20, 21, 22), which are connected with one another and surround the interior container (8) in the form of a jacket, wherein the plate-shaped elements are placed at a distance with respect to the inside of the outer housing (1).

2. Housing according to claim 1, characterized in that the thermally insulating sheath (18) is open on its side directed to the front side of the housing (1), whereas it has, additionally, another plate-shaped element on its back side.

3. Housing according to claim 1 or 2, characterized in that the plate-shaped elements (19, 20, 21, 22), are connected with one another in the area of the edges.

4. Housing according to claim 3, characterized in that the plate-shaped elements (19, 20, 21, 22) are connected with one another, in a form-locking manner, by grooves (27) and/or nose-like projections (26) in the area of the edges.

5. Housing according to one of claims 1 to 4, characterized in that the plate-shaped elements (19, 20, 21, 22) are made of a foam-like thermoplastic, which has polystyrene and polyphenylene ether.

6. Housing according to one of claims 1 to 5, characterized in that an interior space filled with air is present between the interior container (8) and the outer housing (1), which is subdivided by the sheath (18), at least in part, into two spaces (24, 25) with their own convection, which are thermally sealed off with respect to one another.

7. Method for the formation of a thermally insulating sheath of the interior container of a housing according to one of claims 1 to 6, characterized in that a material in the form of granules, which has expandable polystyrene and polyphenylene ether, is introduced into a mold which corresponds to the plate-shaped elements of the thermally insulating sheath of the interior space and is pressed to a thermally insulating, plate-shaped element by supplying hot vapor.
